(19) United States
(12) Patent Application Publication
(10) Pub. No.: US 2025/0220349 A1
(43) Pub. Date: Jul. 3, 2025

(54) TUNING OF MULTIBAND AUDIO SYSTEMS EXECUTING CROSSTALK CANCELLATION

(71) Applicant: HARMAN INTERNATIONAL INDUSTRIES, INCORPORATED, Stamford, CT (US)

(72) Inventor: Alfredo FERNANDEZ FRANCO, Los Angeles, CA (US)

(21) Appl. No.: 19/005,606

(22) Filed: Dec. 30, 2024

Related U.S. Application Data
(60) Provisional application No. 63/617,137, filed on Jan. 3, 2024.

(51) Int. Cl. H04R 3/14; H04R 3/04

(52) U.S. Cl. CPC H04R 3/14; H04R 3/04; H04R 2430/01

(57) ABSTRACT

In various embodiments, a computer-implemented method comprises generating, by an audio playback module from an input audio signal, a plurality of audio feeds that includes at least a midband feed and an additional feed, applying a crosstalk cancellation filter on the midband feed to generate a processed midband audio signal, applying an additional filter on the additional feed to generate an additional audio signal, where the additional filter applies at least a delay value to the additional feed, generating a plurality of processed audio signals based on both the processed midband audio signal and the additional audio signal; and transmitting, by the audio playback module, the plurality of processed audio signals to a plurality of speakers.

### CROSS-REFERENCE TO RELATED APPLICATIONS

This application claims benefit of the United States Provisional patent application titled “TUNING AUDIO SYSTEMS USING CROSSTALK CANCELATION,” filed Jan. 3, 2024, and having Ser. No. 63/617,137. The subject matter of this related application is hereby incorporated herein by reference.

### BACKGROUND

### Field of the Various Embodiments

Embodiments of the present disclosure relate generally to audio reproduction and, more specifically, to tuning of multiband audio systems executing crosstalk cancellation.

### DESCRIPTION OF THE RELATED ART

Audio processing systems use one or more speakers to produce sound in a given space. The one or more speakers generate a sound field, where a user in the environment receives the sound included in the sound field. The one or more speakers reproduce sound based on an input signal that typically includes at least two channels, such as a left channel and a right channel. The left channel is intended to be received by the user's left ear, and the right channel is intended to be received by the user's right ear. Binaural rendering algorithms for producing sound using one or more speakers rely on crosstalk cancellation algorithms. These crosstalk cancellation algorithms rely on measurements taken at a specific location or they rely on a mathematical model that attempts to characterize transmission paths of audio from speakers to the entrance of the car canals of users.

At least one drawback with conventional audio playback systems is crosstalk between left and right channels. In other words, sound produced in the environment by the left channel of the one or more speakers is received by the right ear of the user. Similarly, sound produced in the environment by the right channel of the one or more speakers is received by the left ear of the user. Some audio processing and playback systems utilize conventional crosstalk cancellation techniques. However, application of crosstalk cancellation is not desired for the entire frequency range of an audio signal. For example, low-frequency portions of an audio signal have more limited directional information, resulting in crosstalk being less distinct to the user. Applying crosstalk cancellation at lower frequencies thus potentially results in distortion and a degraded listening experience for the listener. In another example, applying cross-talk cancellation techniques to high-frequency portions of the audio signal produces a filtered audio signal that introduces audible artifacts and other errors, resulting in a harsh sound to the listener. As a result, conventional techniques for audio playback that attempt to reduce crosstalk do not adequately handle the entire frequency range of the audio signal being reproduced.

As the foregoing illustrates, what is needed in the art are more effective techniques for reducing crosstalk when producing sound received by a user in a three-dimensional space in an environment.

### SUMMARY

Various embodiments disclose a computer-implemented method comprises generating, by an audio playback module from an input audio signal, a plurality of audio feeds that includes at least a midband feed and an additional feed, applying a crosstalk cancellation filter on the midband feed to generate a processed midband audio signal, applying an additional filter on the additional feed to generate an additional audio signal, where the additional filter applies at least a delay value to the additional feed, generating a plurality of processed audio signals based on both the processed midband audio signal and the additional audio signal; and transmitting, by the audio playback module, the plurality of processed audio signals to a plurality of speakers.

At least one technical advantage of the disclosed techniques relative to the prior art is that, with the disclosed techniques, an audio processing system can implement crosstalk cancellation for an optimal frequency range of an audio signal without distorting other portions of the audio spectrum. In particular, by separating the audio signal into a plurality of audio feeds for separate frequency ranges, the audio processing system provides crosstalk cancellation without introducing errors in certain frequencies of the audio signal. The disclosed techniques provide improved crosstalk cancellation while reducing spectral distortions caused by errors included in the full audio spectrum. Additionally, the audio intended to be received by the user's left ear and right ear, respectively, more accurately represents the audio input that the audio processing system outputs. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a schematic diagram illustrating an audio processing system according to various embodiments;

FIG. 2 illustrates an example of how crosstalk is observed by a listener from an input signal that is produced by one or more speakers, according to various embodiments;

FIG. 3 illustrates an example of filters that perform crosstalk cancellation based upon an observed position and orientation of a listener within a three-dimensional space, according to various embodiments;

FIG. 4 illustrates a schematic diagram illustrating a plurality of audio processing paths implemented by the audio playback module 120 of FIG. 1, according to various embodiments;

FIG. 5 illustrates an example plurality of audio processing paths implemented by the audio playback module 120 of FIG. 1 to perform binaural rendering of an audio source, according to various embodiments;

FIG. 6 illustrates an example plurality of audio processing paths implemented by the audio playback module 120 of FIG. 1 to perform a multichannel rendering of an audio source, according to various embodiments; and

FIG. 7 illustrates a flow chart of method steps for rendering an audio signal using crosstalk cancellation according to one or more embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### The Audio Processing System

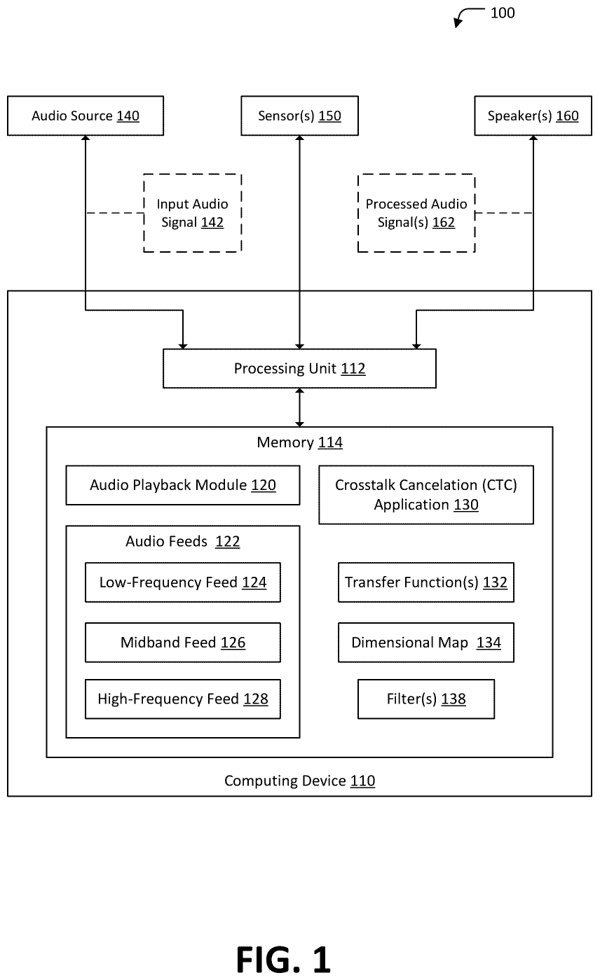

FIG. 1 is a schematic diagram illustrating an audio processing system 100 according to various embodiments. As shown, the audio processing system 100 includes, without limitation, a computing device 110, an audio source 140, one or more sensors 150, and one or more speakers 160. The computing device 110 includes, without limitation, a processing unit 112 and memory 114. The memory 114 stores, without limitation, an audio playback module 120, a plurality of audio feeds 122, a crosstalk cancellation application 130, one or more transfer functions 132, a dimensional map 134, and one or more filters 138. The plurality of audio feeds 122 includes, without limitation, a low-frequency feed 124, a midband feed 126, and a high-frequency feed 128.

In operation, the audio processing system 100 processes sensor data from the one or more sensors 150 to track the location of one or more listeners within the listening environment. The one or more sensors 150 track the position of a listener's head in three-dimensional space, as well as the orientation (e.g., the pitch, yaw, and roll of the listener's head). The crosstalk cancellation application 130 uses the position data and/or the orientation data to locate the relative location of the user's left ear and right ear, respectively. Based upon the position and/or orientation of a listener's head within a three-dimensional environment, the crosstalk cancellation application 130 selects one or more transfer functions 132 utilized for one or more filters 138 that are used to process the input audio signal 142 and generate one or more processed audio signals 162 for playback by the one or more speakers 160 associated with the audio processing system 100. The audio playback module 120 sets the frequency cutoffs (e.g., a low-frequency crossover value and a high-frequency crossover value) for a crossover (not shown) that separates the input audio signal 142 into a plurality of audio feeds 122. In such instances, the plurality of audio feeds 122 include the low-frequency feed 124, the midband feed 126, and the high-frequency feed 128. The audio playback module 120 processes the low-frequency feed 124 and the high-frequency feed 128 in parallel with applying the filters 138 to the midband feed 126.

For example, the midband feed 126 includes audio frequencies within a selected frequency range that the crosstalk cancellation application 130 is to process by applying one or more filters 138. The computing device 110 and/or other devices (e.g., a separate subwoofer) can process the low-frequency feed 124 and/or the high-frequency feed 128 while the crosstalk cancellation application 130 processes the midband feed 126. A combiner (not shown) receives the plurality of audio feeds 122 and outputs a processed audio signal 162. In some embodiments, the audio playback module 120 splits the processed audio signal 162 into a plurality of processed audio signals 162 (e.g., 162(1), 162(2)) that correspond to a plurality of audio channels. In such instances, the plurality of processed audio signals 162 can be distributed to the one or more speakers 160 based on the audio channel layout of the audio processing system 100. Additionally, should the position and/or orientation of the listener's head in a three-dimensional space change during playback of audio provided by the audio source 140, the crosstalk cancellation application 130 can select a different transfer function 132 and, potentially a different filter 138, that the crosstalk cancellation application 130 uses to process the midband feed.

The computing device 110 is a device that drives the one or more speakers 160 to generate, in part, a sound field for a listener by playing back the processed audio signal 162 based on the input audio signal 142 transmitted by an audio source 140. In various embodiments, the computing device 110 is an audio processing unit in a home theater system, a soundbar, a vehicle system, and so forth. In some embodiments, the computing device 110 is included in one or more devices, such as consumer products (e.g., portable speakers, gaming, etc. products), vehicles (e.g., the head unit of a car, truck, van, etc.), smart home devices (e.g., smart lighting systems, security systems, digital assistants, etc.), communications systems (e.g., conference call systems, video conferencing systems, speaker amplification systems, etc.), and so forth. In various embodiments, the computing device 110 is located in various environments including, without limitation, indoor environments (e.g., living room, conference room, conference hall, home office, etc.), and/or outdoor environments, (e.g., patio, rooftop, garden, etc.).

The processing unit 112 can be any suitable processor, such as a central processing unit (CPU), a graphics processing unit (GPU), an application-specific integrated circuit (ASIC), a field programmable gate array (FPGA), a digital signal processor (DSP), and/or any other type of processing unit, or a combination of processing units, such as a CPU configured to operate in conjunction with a GPU. In general, the processing unit 112 can be any technically feasible hardware unit capable of processing data and/or executing software applications.

The memory 114 can include a random-access memory (RAM) module, a flash memory unit, or any other type of memory unit or combination thereof. The processing unit 112 is configured to read data from and write data to the memory 114. In various embodiments, the memory 114 includes non-volatile memory, such as optical drives, magnetic drives, flash drives, or other storage. In some embodiments, separate data stores, such as an external data stores included in a network (“cloud storage”) can supplement the memory 114. The audio playback module 120 and/or the crosstalk cancellation application 130 within the memory 114 can be executed by the processing unit 112 to implement the overall functionality of the computing device 110 and, thus, to coordinate the operation of the audio processing system 100 as a whole. In various embodiments, an interconnect bus (not shown) connects the processing unit 112, the memory 114, the speakers 160, the sensors 150, and any other components of the computing device 110.

The audio playback module 120 processes and renders the input audio signal 142. The audio playback module 120 renders the input audio signal 142 by driving the set of speakers 160 to generate one or more soundwaves corresponding to the input audio signal 142. In various embodiments, the audio playback module 120 receives the set of filters 138 from the crosstalk cancellation application 130 to perform crosstalk cancellation between the left and right channels of the audio source 140. In various embodiments, the audio playback module 120 sets one or more frequency cutoffs to separate the input audio signal 142 into the plurality of audio feeds 122.

The plurality of audio feeds 122 includes the midband feed 126 and one or more additional feeds, such as the high-frequency feed 128 and the low-frequency feed 124. The audio playback module 120 performs crosstalk cancellation on the midband feed 126 by applying the set of filters 138 to generate one or more processed midband audio signals for the portion of the input audio signal 142 with frequencies between the frequency cutoffs. In various embodiments, the audio playback module 120 uses a low-frequency stage to apply a delay and gain to the low-frequency feed 124 to generate a processed low-frequency audio signal that is synchronized and scaled to the processed midband audio signal. Additionally or alternatively, the audio playback module 120 also uses a high-frequency stage to apply a separate delay and gain to the high-frequency feed 128 to generate a processed high-frequency audio signal that is synchronized and scaled to the processed midband audio signal.

In various embodiments, the audio playback module 120 combines the processed low-frequency audio signals, the processed midband signals, and/or the processed high-frequency audio signals to generate a set of processed audio signals 162 for a full audio spectrum. In some embodiments, the audio playback module 120 transmits the processed audio signals 162 to the speakers 160 for rendering. When the speakers 160 reproduce the processed audio signals 162 the environment alters the processed audio signals in a manner that, once reaching the cars of a listener, have reduced or eliminated crosstalk in the midband of the audio spectrum.

The crosstalk cancellation application 130 determines the location of a listener within a listening environment and selects parameters for one or more filters 138, such as one or more transfer functions 132. In such instances, the audio playback module 120 and/or the crosstalk cancellation application 130 use the filters 138 with the selected parameters to generate a portion of a sound field for the location of the listener. In various embodiments, the crosstalk cancellation application 130 selects the transfer functions 132 to minimize or eliminate crosstalk. The transfer functions 132 cause the filters 138 to produce the midband frequencies of the audio in the sound field so that the left channel is perceived by the left ear of the listener with minimal crosstalk from the right channel. Similarly, the transfer functions 132 cause the filters 138 to produce the midband frequencies of the audio in the sound field so that the right channel is perceived by the right ear of the listener with minimal crosstalk from the left channel. In various embodiments, the crosstalk cancellation application 130 uses sensor data transmitted from the sensors 150 to identify the position of the listener, and specifically the head of the listener. Based upon the position and/or the orientation of the listener, the crosstalk cancellation application 130 selects one or more appropriate filters 138 and/or the transfer functions 132. The audio playback module 120 and/or the crosstalk cancellation application 130 uses the selected filters 138 and/or the selected transfer functions 132 to process the midband feed 126 of the input audio signal 142 for playback. In some embodiments, the crosstalk cancellation application 130 sets the parameters for multiple filters 138 corresponding to multiple speakers 160. For example, a first transfer function 132 can be used to generate a first filter 138 that a first speaker 160(1) uses for playback of the processed audio signal 162, and a second transfer function 132 is used to generate a second filter 138 that a second speaker 160(2) uses for playback of the processed audio signal 162. In other embodiments, a filter network is utilized such that the input audio signal 142 and/or the processed audio signal 162 used to drive each of the one or more speakers 160 is passed through a network of multiple filters. Additionally or alternatively, the crosstalk cancellation application 130 tracks the positions and orientations of multiple listeners within the listening environment.

The filters 138 include one or more filters that modify the input audio signal 142. In various embodiments, a given filter 138 modifies the input audio signal 142 by modifying the energy within a specific frequency range, adding directivity information, and so forth. For example, the filter 138 can include filter parameters, such as a set of values that modify the operating characteristics (e.g., center frequency, gain, Q factor, cutoff frequencies, etc.) of the filter 138. In some embodiments, the filter parameters include one or more digital signal processing (DSP) coefficients that steer the generated soundwave in a specific direction. In such instances, the generated processed audio signal 162 is used to generate a soundwave in the direction specified in the processed audio signal 162. For example, the one or more speakers 160 can reproduce audio using one or more processed audio signals 162 to generate a sound field. In some embodiments, the crosstalk cancellation application 130 sets separate filter parameters, such as selecting a different transfer function 132 for separate filters 138 that are usable by different speakers 160. In such instances, the one or more speakers 160 generate the sound field using the separate filters 138. For example, each filter 138 can generate a processed audio signal 162 (e.g., 162(1), 162(2), etc.) for a single speaker 160 within the listening environment.

The transfer functions 132 include one or more transfer functions that the crosstalk cancellation application 130 uses to configure the one or more filters 138. In various embodiments, the crosstalk cancellation application 130 selects the one or more filters 138 configured by the transfer functions 132 to process the input audio signal 142, such as a channel of the audio source 140, to produce an output signal used to driver a speaker 160. Different transfer functions 132 are utilized depending upon the position and orientation of a listener in a three-dimensional space.

In various embodiments, the dimensional map 134 maps a given position within a three-dimensional space, such as a vehicle interior, to filter parameters for the one or more filters 138, such as one or more finite impulse response (FIR) filters. In various embodiments, the crosstalk cancellation application 130 determines a position and an orientation of the listener based on data from the sensors 150. In such instances, the crosstalk cancellation application 130 identifies one or more transfer functions 132 and/or other filter parameters for the filters 138 corresponding to each speaker 160. The crosstalk cancellation application 130 then updates the filter parameters for a specific speaker 160 (e.g., a first filter 138(1) for a first speaker 160(1)) when the head of the listener moves. For example, the crosstalk cancellation application 130 can initially generate filter parameters for a set of filters 138. Upon determining that the head of listener has moved to a new position or orientation, the crosstalk cancellation application 130 then determines whether any of the speakers 160 require updates to the corresponding filters 138. The crosstalk cancellation application 130 updates the filter parameters for any filter 138 that requires updating. In some embodiments, the crosstalk cancellation application 130 generates each of the filters 138 independently. For example, upon determining that a listener has moved, the crosstalk cancellation application 130 can update the filter parameters for a filter 138 (e.g., 138(1) for a specific speaker 160 (e.g., 160(1)). Alternatively, the crosstalk cancellation application 130 updates multiple filters 138.

The dimensional map 134 includes a plurality of points that represent a position and orientation in a three-dimensional space (e.g., points within a six-dimensional space identified by x-, y-, and z-position coordinates and three roll, pitch, and yaw orientations). In various embodiments, the dimensional map 134 maps a position relative to a reference position in a given listening environment. In some embodiments, the dimensional map 134 also maps an orientation relative to a reference orientation in the listening environment. In various embodiments, the dimensional map 134 can be generated by conducting acoustic measurements in the three-dimensional space for filter parameters, such as transfer functions 132, that minimize or eliminate crosstalk. In such instances, the dimensional map 134 is saved in the memory 114 of the audio processing system 100 and is used to configure the filters 138.

In some embodiments, the dimensional map 134 includes specific coordinates relative to a reference point. For example, the dimensional map 134 can store the potential positions and orientations of the head of a listener as a distance and angle from a specific reference point. In some embodiments, the dimensional map 134 includes additional orientation information, such as pitch, yaw, and roll, which characterize the orientation of the head of the listener. In some embodiments, the dimensional map 134 also include as a set of angles (e.g., {μ, φ, ψ}) relative to a normal orientation of the head of the listener. In such instances, a respective position and orientation defined by a point in dimensional map 134 is associated with one or more transfer functions 132 used to generate the filter 138. For example, the dimensional map 134 can be structured as a set of points, each of which is associated with a particular position and a particular orientation in an environment. Each of the points is associated with the one or more filters 138 and/or the one or more transfer functions 132 that can be used by the audio playback module 120 and/or the crosstalk cancellation application 130 to reduce or eliminate crosstalk.

In various embodiments, the crosstalk cancellation application 130 selects the one or more transfer functions 132 to configure filters 138, where the transfer functions 132 are identified by the dimensional map 134. The transfer functions 132 are used to configure the filters 138 that process the input audio signal 142. In some embodiments, the transfer functions 132 are identified based on a mathematical distance, such as a barycentric distance, of a set of points characterizing the position and orientation of listener's head to one or more of the points from the set of points in the dimensional map 134. In one example, a given position and/or a given orientation of a listener is characterized by coordinates in six-dimensional space. In some embodiments, a nearest set of points to the coordinates is then identified within the dimensional map 134 using a graph search algorithm, such as a Delaunay triangulation. A barycentric distance to each of the nearest set of points is determined, and the transfer functions 132 associated with the closest point in the dimensional map 134 are used to configure the filters 138 that filter the processed audio signal 162 that the speakers 160 play back.

As another example, a simplified approach to identifying transfer functions 132 includes reducing the number of dimensions of a user's position and orientation that are considered when identifying a set of transfer functions specified by the dimensional map 134. As noted above, the dimensional map 134 includes a set of points in six-dimensional space to account for three parameters representing position and three parameters representing orientation. To reduce mathematical complexity, a reduced set of parameters representing the position and orientation of the user can be considered. For example, one or more of the parameters representing orientation can be removed and a nearest set of points are identified based on the mathematical distance from coordinates characterizing the position and orientation of listener's head to one or more of the points from the set of points in the dimensional map 134. Examples of coordinates that can be removed include yaw, pitch, and/or roll angles. In one scenario, only the position of the user's head and a yaw angle are considered, which reduces complexity to a consideration of four dimensions. As another example, only the position of the user's head along with yaw and pitch angle are considered, which reduces complexity to five dimensions.

As another example, an alternative simplified approach to identifying transfer functions 132 includes reducing dimensionality of the dimensional map 134. As noted above, the dimensional map 134 includes a set of points in six-dimensional space to account for three parameters representing position and three parameters representing orientation. To reduce mathematical complexity, a dimensional map 134 that includes a set of points mapped in three-, four-, or five-dimensional space can be generated and utilized. For example, the dimensional map 134 can map only the position of the user's head in three-dimensional space and a yaw angle representing orientation, resulting in a four-dimensional map. As another example, the dimensional map 134 maps only the position of the user's head and two parameters characterizing orientation, which reduces complexity of the dimensional map 134 to five dimensions.

Another example of a simplified approach to reducing dimensionality of the dimensional map 134 is to use multiple dimensional maps 134 that include three dimensions representing position in three-dimensional space can be utilized. Each of the three-dimensional maps are associated with a particular orientation parameter or a range of the orientation parameter. For example, each of the three-dimensional maps are associated with a yaw angle or a range of yaw angles. In one scenario, a first three-dimensional map is associated with a yaw angle of zero to ten degrees, a second three-dimensional map is associated with a yaw angle of greater than ten to twenty degrees, and so on. In this approach, based on a detected yaw angle of the user's head, a three-dimensional map is selected. Then, based on coordinates based on the user's detected position, a point corresponding to transfer functions 132 within the three-dimensional map is identified, and the transfer functions 132 are used to configure a filter 138.

The one or more sensors 150 include various types of sensors that acquire data about the listening environment. For example, the computing device 110 can include auditory sensors to receive several types of sound (e.g., subsonic pulses, ultrasonic sounds, speech commands, etc.). In some embodiments, the sensors 150 includes other types of sensors. Other types of sensors include optical sensors, such as RGB cameras, time-of-flight cameras, infrared cameras, depth cameras, a quick response (QR) code tracking system, motion sensors, such as an accelerometer or an inertial measurement unit (IMU) (e.g., a three-axis accelerometer, a gyroscopic sensor, and/or a magnetometer), pressure sensors, and so forth. In addition, in some embodiments, the sensor(s) 150 can include wireless sensors, including radio frequency (RF) sensors (e.g., sonar and radar), and/or wireless communications protocols, including Bluetooth, Bluetooth low energy (BLE), cellular protocols, and/or near-field communications (NFC). In various embodiments, the crosstalk cancellation application 130 uses the sensor data acquired by the sensors 150 to identify transfer functions 132 utilized for filters 138. For example, the computing device 110 includes one or more emitters that emit positioning signals, where the computing device 110 includes detectors that generate auditory data that includes the positioning signals. In some embodiments, the crosstalk cancellation application 130 combines multiple types of sensor data. For example, the crosstalk cancellation application 130 can combine auditory data and optical data (e.g., camera images or infrared data) in order to determine the position and orientation of the listener at a given time.

### Configuration of Crosstalk Cancellation Filters

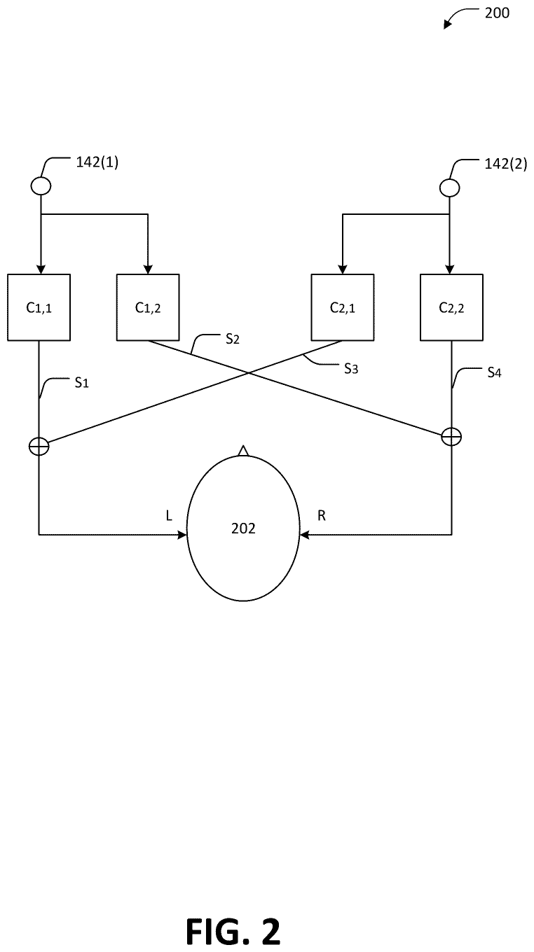

FIG. 2 illustrates an example of how crosstalk is observed by a user from an input signal that is produced by the one or more speakers 160. As shown, configuration 200 includes, without limitation, input audio signals 142 (e.g., 142(1), 142(2)), crosstalk representations C (e.g., C_{1.1}, etc.), audio signals S (e.g., S₁, etc.), and a listener 202.

In various embodiments, when an audio signal is played back by one or more speakers 160, crosstalk presents itself within audio that is measured at a left ear L and right ear R of the listener 202. Crosstalk naturally occurs when speakers are remotely located from a listener 202 absent crosstalk cancellation. The input audio signal 142(1) represents a desired signal at the left car of the listener 202, or a left channel of the audio source 140. The input audio signal 142(2) represents a desired signal at the right ear of the listener 202, or a right channel of the audio source 140.

When audio is played back in an environment, such as by the speakers 160 that are remotely located from the cars of the listener 202, crosstalk occurs. The crosstalk representations C_{1.1} and C_{1.2} represent functions that characterize how the environment affects the input audio signal 142(1) when played back by the audio processing system 100. S₁ and S₂ represent respective portions of the input audio signal 142(1) that are heard by the left and right ears of the listener 202, respectively. For example, when the input audio signal 142(1) is played by the corresponding one or more speakers 160, the environment alters the input audio signal 142(1) according to C_{1.1} so that the audio S₁ reaches the left ear of listener 202. Similarly, the environment alters the input audio signal 142(1) according to C_{1,2} so that the audio S₂ reaches the right ear of listener 202. S₂ represents a portion of the input audio signal 142(1) that results in crosstalk that arrives at the right car of the listener 202.

C_{2.1} and C_{2.2} represent functions that characterize how the environment affects the input audio signal 142(2) when played back by the audio processing system 100. S₃ and S₄ represent respective portions of the input audio signal 142(2) that are heard by the left and right ears of the listener 202, respectively. For example, when the input audio signal 142(2) is played by the corresponding one or more speakers 160, the environment alters the input audio signal 142(2) according to C_{2.2} so that the audio S₄ reaches the right ear of listener 202. Similarly, the environment alters the input audio signal 142(2) according to C_{2.1} so that the audio S₃ reaches the left ear of listener 202. S₃ represents a portion of the input audio signal 142(2) that results in crosstalk that arrives at the left ear of the listener 202.

Accordingly, embodiments of the disclosure include the audio playback module 120 and/or the crosstalk cancellation application 130 applying the filters 138 on one or more input audio signals 142 to generate portions of the one or more processed audio signals 162. The one or more processed audio signals 162 that are then used to drive the one or more speakers 160 to reduce or eliminate crosstalk caused by the environment.

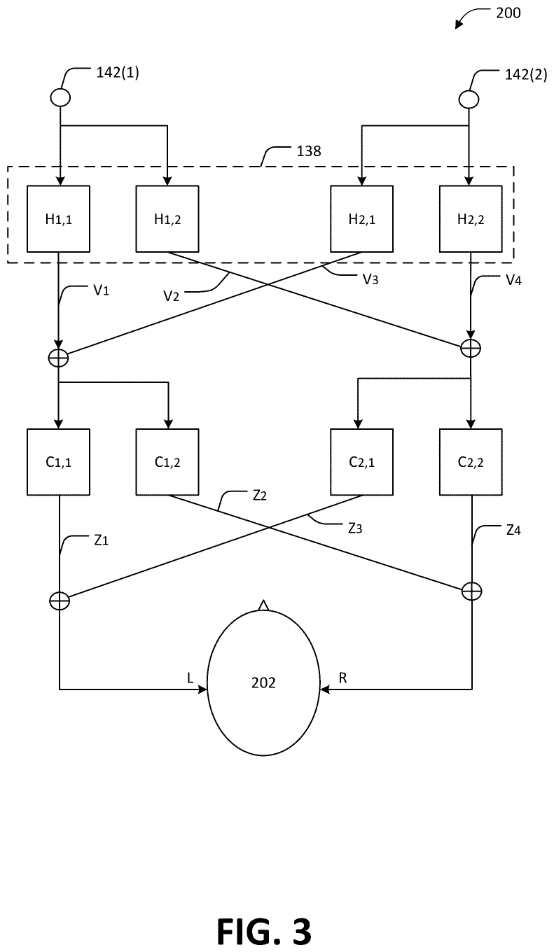

FIG. 3 illustrates an example of filters 138 that perform crosstalk cancellation based upon an observed position and orientation of a user within a three-dimensional space according to various embodiments of the disclosure. As shown in FIG. 3, the input audio signal 142(1) corresponds to the left channel of audio source 140, and input audio signal 142(2), corresponds to the right channel of audio source 140. The input audio signals 142(1)-142(2) are played back by the one or more speakers 160. As described above in connection with FIG. 2, the input audio signal 142(1) represents a desired signal at the left ear of the listener 202, or a left channel of the audio source 140. The input audio signal 142(2) represents a desired signal at the right ear of the listener 202, or a right channel of the audio source 140. Without filtering, when audio is played back in a three-dimensional environment, such as by the speakers 160 that are remotely located from the cars of the listener 202, crosstalk can occur, as described in FIG. 2.

In various embodiments, the crosstalk cancellation application 130 determines the position and orientation of the head of the listener 202 based on sensor data from the sensors 150, such as one or more cameras or other devices that detect a position or orientation of the listener 202. The crosstalk cancellation application 130 further determines, based on the dimensional map 134, the distances between one or more positions within the environment. The distances can include one or more distances between the position and orientation of head of the listener 202 to one or more points within the dimensional map 134. In one example, the crosstalk cancellation application 130 calculates a mathematical distance, such as a barycentric distance or a Euclidean distance, of the position and/or the orientation of the head of the listener 202 from points within the dimensional map 134. In such instances, the crosstalk cancellation application 130 can identify the one or more transfer functions 132 associated with the nearest point, according to the calculated barycentric or Euclidean distance. In the example of FIG. 3, the crosstalk cancellation application 130 selects one or more transfer functions 132 that are used to configure a set of filters 138. The set of filters 138 filter the portions of input audio signal 142(1) and 142(2) that are played back by the one or more speakers 160 to reduce or eliminate crosstalk from the portion of the audio signals Z₁, Z₂, Z₃, and Z₄ that arrive at the left and right ears of the listener 202.

As shown in FIG. 3, the filters H_{1.1} and H_{1.2} filter portions of the input audio signal 142(1) and the filters H_{2.1} and H_{2.2} filter portions of the input audio signal 142(2). In this manner, when representations of the input audio signals 142(1)-142(2) are output in the environment, the effects of crosstalk, as represented by the crosstalk representations C_{1.1}, C_{1.2}, C_{2.1}, and C_{2.2}, is reduced or eliminated. The audio signals V₁ and V₂ represent respective filtered portions of the input audio signal 142(1) that are produced by the filters H_{1.1} and H_{1.2}, and can be output to one or more speakers 160, respectively. The audio signals V₃ and V₄ represent respective filtered portions of the input audio signal 142(2) that are filtered by the filters H_{2.1} and H_{2.2}, and can be output to one or more speakers 160, respectively. Therefore, when the environment alters the audio signals output by the filters and played back by the one or more speakers 160 (as represented by the crosstalk representations C_{1.1}, C_{1.2}, C_{2.1}, and C_{2.2}) the audio signals reaching the cars of the listener 202 have reduced or eliminated crosstalk.

As shown in FIG. 3, the filters H_{1.1} and H_{1.2} filter the input audio signal 142(1) to produce the filtered audio signals V₁ and V₂ that are played back by the one or more speakers 160 so that, when subjected to the effects of the environment by C_{1.1} and C_{2.1}, the resultant audio signals Z₁ and Z₃ arriving at the left ear of the listener 202 correspond only to the input audio signal 142(1), the left channel of the audio source 140. Similarly, the filters H_{2.1} and H_{2.2} filter the input audio signal 142(2) to produce the audio signals V₃ and V₄ that are played back by the one or more speakers 160 so that, when subjected to the effects of the environment by C_{1.2} and C_{2.2}, the resultant audio signals Z₂ and Z₄ arriving at the right ear of the listener 202 correspond only to the input audio signal 142(2), the right channel of the audio source.

As noted above, in various embodiments, the crosstalk cancellation application 130 selects one or more transfer functions 132 that are used to configure a set of filters H_{1.1}, H_{1.2}, H_{2.1}, and H_{2.2} that filter the input audio signal 142(1) and the input audio signal 142(2) based on the position and/or the orientation of the listener 202. The position and/or the orientation of the listener 202 are determined based upon sensor data generated by the one or more sensors 150. As the position and/or the orientation of the listener 202 changes, the crosstalk cancellation application 130 updates the transfer functions 132 used to configure the filters H_{1.1}, H_{1.2}, H_{2.1}, and H_{2.2} by determining whether the movement of the listener 202 to an updated position or orientation corresponds to a different set of transfer functions 132 defined by the dimensional map 134. In this way, the crosstalk cancellation application 130 performs crosstalk cancellation based on the current position and/or the current orientation of the listener 202, as well as when the listener 202 adjusts the position and/or the orientation within a given three-dimensional space characterized by the dimensional map 134.

### Rendering of Multiband Audio Signals Using Crosstalk Cancellation

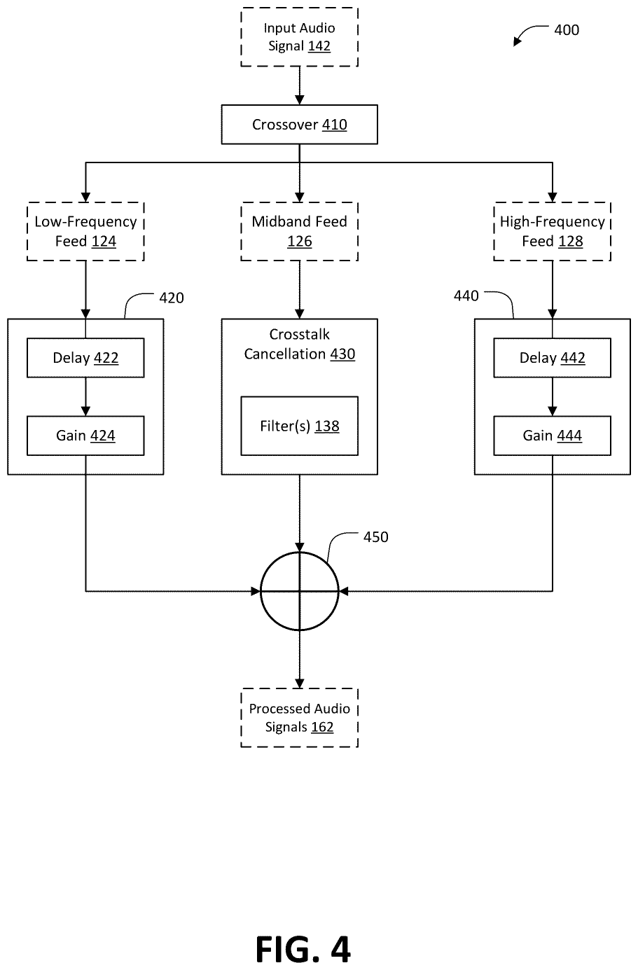

FIG. 4 illustrates a schematic diagram illustrating a plurality of audio processing paths implemented by the audio playback module 120 of FIG. 1, according to various embodiments. As shown, the configuration 400 includes, without limitation, a crossover 410, a low-frequency filter 420, a crosstalk cancellation stage 430, a high-frequency filter 440, and a combiner 450. The low-frequency filter 420 includes, without limitation, a delay value 422 and a gain value 424. The high-frequency filter 440 includes, without limitation, a delay value 442 and a gain value 444.

In operation, the audio playback module 120 uses the configuration 400 to process an input audio signal 142 into a set of processed audio signals 162 for playback by the set of speakers 160. In various embodiments, the audio playback module 120 implements the crossover 410 to generate the plurality of audio feeds 122 from the input audio signal 142 and employs parallel processing of the respective audio feeds 122, including performing crosstalk cancellation on the midband feed 126. The audio playback module 120 then uses the combiner 450 to combine the processed audio signals of the respective audio feeds 122 to generate a set of processed audio signals 162. When played back in the environment, a processed midband audio signal portion of the processed audio signals 162 arrives at the left and right ear of the listener 202, respectively, with crosstalk being reduced or eliminated.

The crossover 410 splits the input audio signal 142 into the plurality of audio feeds 122. In various embodiments, the audio playback module 120 sets a plurality of cutoff frequencies that are usable to separate a given audio signal into a plurality of frequency ranges. In such instances, the cutoff frequencies can specify the frequency range that is subject to crosstalk cancellation and one or more other ranges that are processed using parallel processing stages. The crossover 410 splits the input audio signal into separate frequency ranges to produce the plurality of audio feeds 122. In some embodiments, the audio playback module 120 converts input audio signal 142 to the frequency domain before the crossover generates the plurality of audio feeds 122. For example, the audio playback module 120 can use Fast Fourier Transform (FFT) to transform the input audio signal 142 from the time domain to the frequency domain. For example, the audio playback module 120 can use an FFT to transform the input audio signal 142 into one or more frequency components that correspond to the plurality of audio feeds 122. In such instances, the crossover 410 can separate the frequency components into the respective audio feeds 122.

In some embodiments, one or more of the cutoff frequencies used by the crossover 410 are set during a design phase. For example, the audio playback module 120 can base one or more of the cutoff frequencies on mechanical-acoustical characteristics of transducers (e.g., the speakers 160) included in the audio processing system 100. For example, a given speaker 160 has a resonant frequency and can output distorted audio when reproducing frequencies that are outside of a threshold range round the resonant frequency. In such instances, the audio playback module 120 determines the optimal frequency range of the speaker 160 and sets the cutoff frequencies based on the optimal frequency range. In another example, the audio playback module 120 can determine that a separate device, such as a subwoofer, is to receive a low-frequency feed. The low-frequency feed can be preset based on the operating characteristics of the subwoofer, such as the portion of the audio spectrum below a specific frequency (e.g., below 200 Hz). In such instances, the audio playback module 120 can set the cutoff frequency to reflect the cutoff frequency used by the subwoofer.

Alternatively, in some embodiments, the cutoff frequencies are set during a subsequent stage. For example, a user can enter input values for one or more cutoff frequencies as manual input to determine an enjoyable listening experience. The audio playback module 120 can respond in real time by changing the cutoff frequencies based on the manual input. In another example, the audio playback module 120 can store various cutoff frequencies as part of one or more presets. The user can select one of the presets and the audio playback module 120 can respond by retrieving the stored cutoff frequencies and setting the cutoff frequencies for the crossover 410.

In various embodiments, the audio playback module 120 implements the low-frequency stage by processing the low-frequency feed 124 using the low-frequency filter 420. In various embodiments, the low-frequency filter 420 is configurable based on the delay value 422 and/or the gain value 424. For example, the audio playback module 120 can set the delay value 422 based on a delay associated with the crosstalk cancellation stage 430 and can set the gain value 424 to compensate for mismatched energy levels that are a result of the parallel processing paths. In some embodiments,

In some embodiments, the delay value 422 used by the low-frequency filter 420 is set during the design phase. For example, the delay value 422 can be set as an average of a set of measurements of delays caused by the crosstalk cancellation stage 430 applying the filters 138 to the midband feed 126. In some embodiments, the delay compensates for multiple factors. For example, the audio playback module 120 can determine a delay value that is due to factors including both the crosstalk cancellation stage and a distance between a separate device for which the low-frequency output audio signal is to appear to originate from and the set of speakers 160. In such instances, the audio playback module 120 can determine the delay value 422 that compensates for a combination of the multiple factors. Alternatively, in some embodiments, the delay value 422 is set during a subsequent stage. For example, a user can provide a manual input of a delay value 422. The audio playback module 120 can respond in real time by changing the delay value 422 based on the manual input.

Additionally or alternatively, the gain value 424 used by the low-frequency filter 420 is set during the design phase. For example, the gain value 424 can be derived from a measured energy level difference between the midband feed 126 a processed midband audio signal output from the crosstalk cancellation stage. In such instances, the measured energy level difference can be set as the gain value 424 that is to be applied to the low-frequency feed 124. Alternatively, in some embodiments, the gain value 424 is set during a subsequent stage. For example, a user can enter input values to specify the gain value 424 (e.g., adjusting the level of a subwoofer that includes the low-frequency filter 420). The audio playback module 120 can respond in real time by changing the gain value 424 based on the manual input.

In various embodiments, the audio playback module 120 implements the high-frequency stage by processing the high-frequency feed 128 using the high-frequency filter 440. In various embodiments, the high-frequency filter 440 is configurable based on the delay value 442 and/or the gain value 444. For example, the audio playback module 120 can set the delay value 442 based on a delay associated with the crosstalk cancellation stage 430 and can set the gain value 444 to compensate for mismatched energy levels that are a result of the parallel processing paths. In some embodiments, the gain value 444 is equivalent to the gain value 424 and/or the delay value 442 is equivalent to the delay value 422. For example, the audio playback module 120 can set both delay values 422 and 442 based on a delay associated with applying the set of filters 138 (e.g., an average of delays for the respective filters 138). Alternatively, in another example, the audio playback module 120 can set the delay value for the high-frequency stage at a different value than the delay value for the low-frequency stage (e.g., setting the delay values 442 to a different value than the delay value 422).

The audio playback module 120 uses the crosstalk cancellation stage 430 to apply the set of filters 138 to the midband feed 126. In various embodiments, the audio playback module 120 retrieves the set of filters 138 configured by the crosstalk cancellation application 130, where applying the filters 138 to the midband feed 126. In various embodiments, the audio playback module 120 applying the crosstalk cancellation stage 430 adds a delay and/or a gain to the processed midband audio signal output by the crosstalk cancellation stage 430. For example, each filter 138 can add a separate delay to the resultant audio signal. In such instances, the audio playback module 120 can determine the delay value 422 and/or the delay value 442 as an average of each of the delays generated by the respective filters 138. Additionally or alternatively, in some embodiments, the amplitude of the electromagnetic energy included in the processed midband audio signal output by the crosstalk cancellation stage 430 is different than the midband feed 126. In such instances, the audio playback module 120 can determine the change in amplitude and set the difference as the gain value 424 and/or the gain value 444.

In various embodiments, the audio playback module 120 implements one or more combiners 450 to combine the processed audio signals generated by the separate processing stages to generate the set of processed audio signals 162. For example, the audio playback module 120 can combine the processed midband audio signal, the processed low-frequency audio signal, and the processed high-frequency audio signal to generate multiple processed audio signals 162 that are usable for playback by the set of speakers 160. In some embodiments, the processed low-frequency audio signal remains separate from the other processed audio signals. When played back in the environment, the processed midband audio signal portion of the processed audio signals 162 arrive at the left and right ear of the listener 202, respectively, with crosstalk being reduced or eliminated.

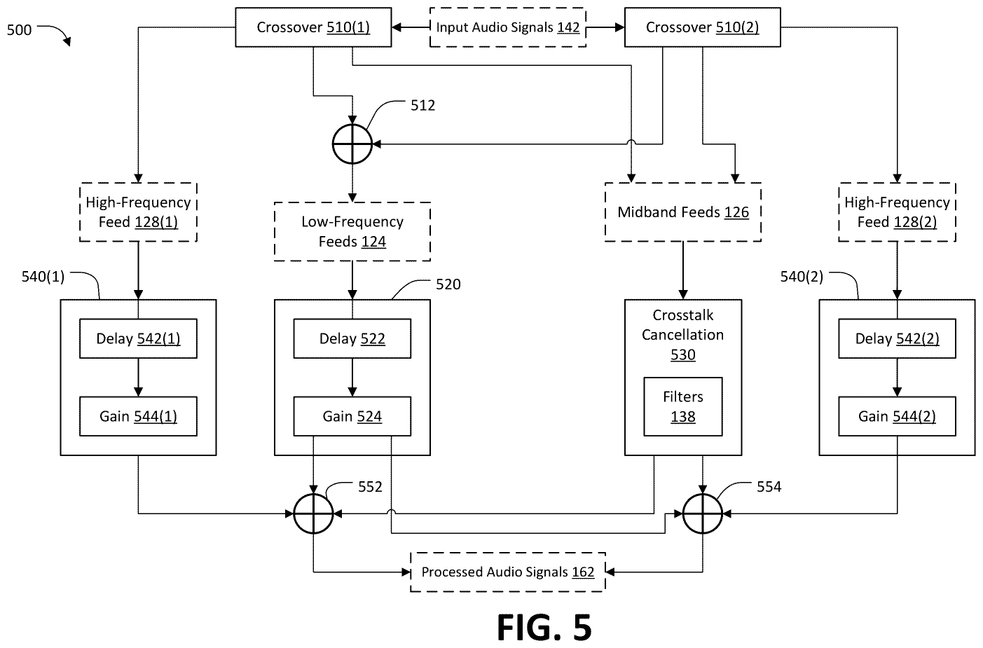

FIG. 5 illustrates an example plurality of audio processing paths implemented by the audio playback module 120 of FIG. 1 to perform binaural rendering of an audio source, according to various embodiments. As shown, the configuration 500 includes, without limitation, a set of crossovers 510 (e.g., 510(1) and 510(2)), a low-frequency filter 520, a crosstalk cancellation stage, a set of high-frequency filters 540 (e.g., 540(1) and 540(2)), and combiners 512, 552, 554. The low-frequency filter 520 includes, without limitation, a delay value 522 and a gain value 524. Each high-frequency filter 540 includes, without limitation, a delay value 542 and a gain value 544.

The configuration 500 is a version of the configuration 400 implemented by the audio playback module 120 to generate processed audio signals for reproduction by the set of speakers 160. In various embodiments, the audio playback module 120 implements configuration 500 to perform a binaural rendering of the audio source 140. The processed audio signals 162 for the binaural rendering includes a processed left audio channel signal 162(1) intended for the left ear of the listener 202 within the environment and a processed right audio channel signal 162(2) intended for the right ear of the listener 202 within the environment.

In various embodiments, the audio playback module 120 uses the combiner 512 to combine the low-frequency feeds 124 from the crossovers 510(1) and 510(2) to produce a combined low-frequency feed 124. In such instances, the audio playback module 120 can apply the low-frequency filter 520 to the combined low-frequency feed 124 to generate the processed low-frequency audio signal. The audio playback module 120 can then use the combiners 552 and 554 to combine the processed low-frequency audio signal with the respective outputs of the separate crosstalk cancellation and high-frequency stages.

Additionally or alternatively, in some embodiments, a separate device (e.g., a subwoofer) processes the low-frequency feed 124. In such instances, the audio playback module 120 can cause the separate device to apply a low-frequency filter 620 that includes the selected delay value 622 and the selected gain value 624.

In various embodiments, the audio playback module 120 includes a crosstalk cancellation stage 530 to process multiple midband feeds 126 (e.g., the midband feeds 126(1) and 126(2)). For example, the audio playback module 120 can use the crossovers 510(1) and 510(2) on separate input audio signals 142 to generate separate midband feeds 126(1) and 126(2). In such instances, each midband feed 126(1) and 126(2) can represent different audio channels, where the midband feed 126(1) includes portions of the input audio signal 142(1) intended for the left ear of the listener 202 and the midband feed 126(2) includes portions of the input audio signal 142(2) intended for the right ear of the listener 202. The crosstalk cancellation stage 530 receives each of the midband feeds 126(1) and 126(2) to and generates a set of processed midband audio signals for each of the respective audio channels.

In various embodiments, the audio playback module 120 includes multiple high-frequency filters 540 (e.g., the high-frequency filters 540(1) and 540(2)) to process multiple high-frequency feeds 128 (e.g., the high-frequency feeds 128(1) and 128(2)). The respective high-frequency filters 540 generate respective processed high-frequency audio signals. In such instances, the processed high-frequency left audio channel signal produced by the high-frequency filter 540(1) is the high-frequency portion of the left audio channel. Similarly, the processed high-frequency right audio channel signal produced by the high-frequency filter 540(2) is the high-frequency portion of the right audio channel.

The audio playback module 120 combines the processed high-frequency left audio channel signal with the processed low-frequency audio signal and processed midband left audio channel signal via the combiner 552 to produce the processed left audio channel signal 162(1). The audio playback module 120 combines the processed high-frequency right audio signal with the processed low-frequency audio signal and processed midband right audio channel signal via the combiner 554 to produce the processed right audio channel signal 162(2). The audio playback module 120 transmits the set of processed audio signals 162 to the set of speakers 160 (e.g., speakers 160(1) and 160(2)) to perform the binaural rendering by reproducing the set of processed audio signals. When played back in the environment, the processed midband audio signal portion of the set of processed audio signals 162 arrive at the left and right ear of the listener 202, respectively, with crosstalk being reduced or eliminated.

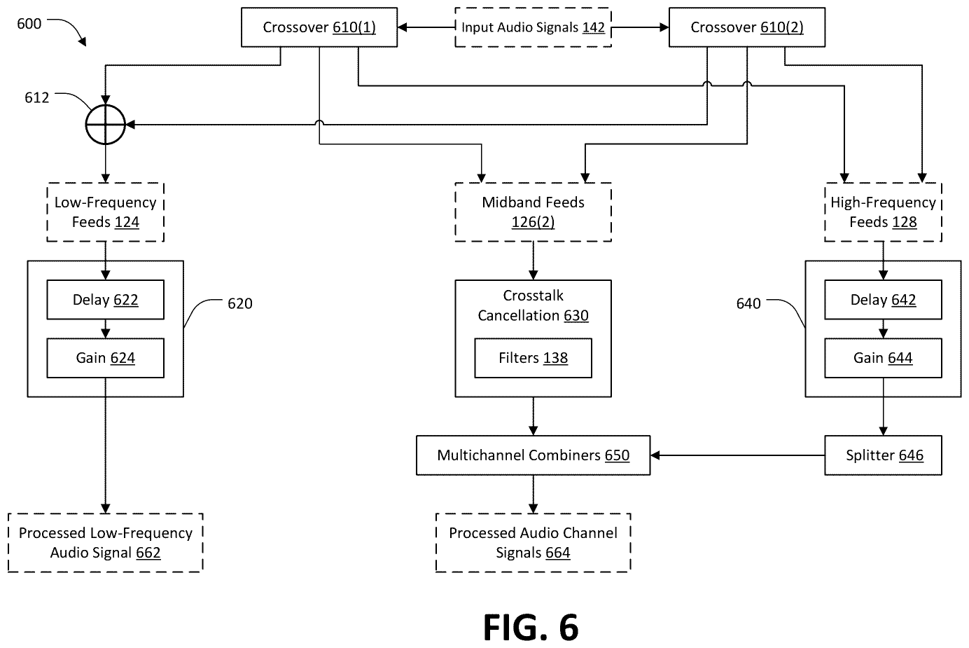

FIG. 6 illustrates an example plurality of audio processing paths implemented by the audio playback module 120 of FIG. 1 to perform a multichannel rendering of an audio source, according to various embodiments. As shown, the configuration 600 includes, without limitation, a set of crossovers 610 (e.g., 610(1) and 610(2)), a low-frequency filter 620, a crosstalk cancellation stage 630, a high-frequency filter 640, a splitter, and a set of multichannel combiners 650. The low-frequency filter 620 includes, without limitation, a delay value 622 and a gain value 624. The high-frequency filter 640 includes, without limitation, a delay value 642 and a gain value 644.

The configuration 600 is a version of the configuration 400 implemented by the audio playback module 120 to generate processed audio signals for reproduction by the set of speakers 160. In various embodiments, the audio playback module 120 implements configuration 600 to perform a multichannel rendering of the audio source 140. For example, the channel layout of the audio processing system 100 can be represented a number delineated as X.Y.Z, where “X” is the capability for the general purpose type audio channels (e.g., for speakers placed on a horizontal level), “Y” is the capability for the bass type audio channel, and “Z” is the capability for the top type audio channel (e.g., speakers oriented upwards within the speaker unit). The audio processing system can have a 5.1 multichannel system with a 3.1.2 layout, including five channels for midband and high-frequency signals (e.g., three general purpose type audio channels and two top type audio channels) and a bass type audio channel. The five channels for midband and high-frequency signals includes a group of processed left audio channel signals (e.g., processed left audio channel signals 162(1)-162(5)) intended for the left ear of the listener 202 within the environment and a group of processed right audio channel signals (e.g., 162(6)-162(10)) intended for the right ear of the listener 202 within the environment.

In various embodiments, the processed low-frequency audio signal 662 remains separate from the other processed audio signals. For example, when producing audio for a 5.1 multichannel configuration, a separate device (e.g., a subwoofer) can receive the combined low-frequency feeds 124 generated by the combiner 612. In such instances, the separate device can apply the low-frequency filter 620 with the delay value 622 and/or the gain value 624 to generate and output the processed low-frequency audio signal 662.

In various embodiments, the set of filters 138 that the audio playback module 120 applies in the crosstalk cancellation stage 630 includes a pair of filters 138 for each of the “X” and “Z” channels identified in the X.Y.Z. channel layout. For example, when the audio processing system 100 is processing the audio signal for a 3.1.2 channel configuration, the set of filters 138 can include ten filters (a pair of filters 138 for each of the three horizontal channels and two top channels). In such instances, the audio playback module 120 applies one of the set of filters 138 to the respective midband feeds 126 (e.g., applying a first bank of filters 138(1) to the midband feed 126(1) and applying a first bank of filters 138(1) to the midband feed 126(2)). The application of the set of filters 138 generates a plurality of processed midband audio signals for each of the respective filters 138. Following the above example, the audio playback module 120 applies the ten filters on the respective midband feeds 126 to generate ten separate processed midband audio signals, where each channel includes a respective processed left audio channel signal and a processed right audio channel signal.

Additionally or alternatively, in some embodiments, the high-frequency feeds 128 from two or more crossovers 610 (e.g., the crossovers 610(1) and 610(2)) are received by a single high-frequency filter 640. The audio playback module 120 then applies the high-frequency filter 640 to the respective high-frequency feeds 128. In such instances, the audio playback module 120 can implement a splitter 646 to apply additional gains to the processed high-frequency audio signals for the respective audio channels. The processed high-frequency audio channel signals are then available for the multichannel combiners 650 to combine with multiple processed midband audio channel signals. For example, when the audio processing system 100 includes 5.1 multichannel configuration, the audio playback module 120 can implement the splitter 646 to split the processed high-frequency audio signal into five channels for combination with five processed midband audio signals.

The multichannel combiners 650 include a plurality of combiners to combine the processed midband audio signals and the processed high-frequency audio signal for each channel. For example, the multichannel combiners 650 can include a center combiner 650(1) for the center audio channel. In such instances, the center combiner 650(1) can receive and combines the processed midband left audio signal for the center channel, the processed midband right audio signal for the center channel, and the high-frequency audio signal for the center channel. The center combiner 650(1) can generate a processed audio channel signal 664(1) for the center channel. When played back in the environment, the processed midband audio signal portion of the processed audio channel signal 664(1) for the center channel arrive at the left and right ear of the listener 202, respectively, with crosstalk being reduced or eliminated.

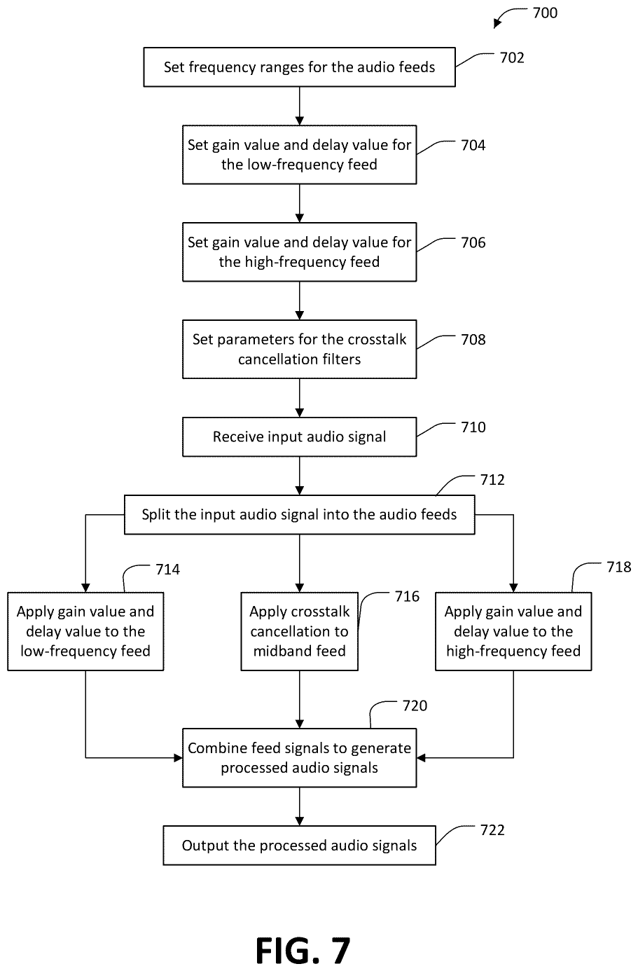

FIG. 7 a flow chart of method steps for rendering an audio signal using crosstalk cancellation according to one or more embodiments. Although the method steps are described with reference to the embodiments of FIGS. 1-6, persons skilled in the art will understand that any system configured to implement the method steps, in any order, falls within the scope of the present disclosure.

A method 700 begins at step 702, where the audio processing system 100 sets the frequency ranges for the audio feeds. In various embodiments, the audio playback module 120 sets a plurality of cutoff frequencies that are usable to separate an audio signal into a plurality of frequency ranges. In such instances, the cutoff frequencies specify the frequency range that is subject to crosstalk cancellation. In some embodiments, one or more of the cutoff frequencies is set during a design phase. For example, the audio playback module 120 can base one or more of the cutoff frequencies on mechanical-acoustical characteristics of transducers (e.g., the speakers 160) included in the audio processing system 100. In another example, the audio playback module 120 can determine that a subwoofer is to receive a low-frequency feed for the portion of the audio spectrum below a specific frequency (e.g., below 200 Hz). In such instances, the audio playback module 120 can set the cutoff frequency to reflect the cutoff frequency for the subwoofer. Alternatively, in some embodiments, the cutoff frequencies is set during a subsequent stage. For example, a user can enter input values for one or more cutoff frequencies (e.g., manual input, selection from a plurality of presets, etc.). In such instances, the audio playback module 120 can set the cutoff frequencies in response to the user input.

At step 704, the audio processing system 100 sets the gain value and the delay value for the low-frequency feed. In various embodiments, the audio playback module 120 sets a gain value 424, 524, 624 and/or a delay value 422, 522, 622 to be applied by the low frequency filter 420, 520, 620 as part of the low-frequency stage of processing. In some embodiments, the gain value 424, 524, 624 and/or the delay value 422, 522, 622 is set during the design phase. For example, the delay value 422, 522, 622 can be set as an average of the delay created by the crosstalk cancellation stage 430, 530, 630 applying the filters 138 to the midband feed 126. In some embodiments, the delay compensates for multiple factors. For example, the audio playback module 120 can determine a delay that is due to factors including both the crosstalk cancellation stage and a distance between the separate device and the set of speakers 160. In such instances, the audio playback module 120 can determine the delay value 422, 522, 622 to compensate for the multiple factors. The gain value 424, 524, 624 can be derived from a measured energy level difference between the processed midband audio signal and the midband feed. In such instances, the measured energy level difference can be set as the gain value 424, 524, 624 that is to be applied to the low-frequency feed 124. Alternatively, in some embodiments, the gain and delay values is set during a subsequent stage. For example, a user can enter input values to specify the gain value 424, 524, 624 (e.g., adjusting the level of a subwoofer to adjust the gain value 424, 524, 624).

At step 706, the audio processing system 100 sets the gain value and the delay value for the high-frequency feed. In various embodiments, the audio playback module 120 sets one or more gain values 444, 544, 644 and/or one or more delay values 442, 542, 642 to be applied by the one or more high-frequency filters 440, 540, 640 as part of the one or more high-frequency stages of processing. In some embodiments, the gain value 444, 544, 644 is equivalent to the gain value 424, 524, 624 and/or the delay value 442, 542, 642 is equivalent to the delay value 422, 522, 622. For example, the audio playback module 120 can set both delay values 422, 522, 622 and 442, 542, 642 based on a delay associated with applying the set of filters 138 (e.g., an average of delays for the respective filters 138). Alternatively, in another example, the audio playback module 120 can set one or more delay values 442, 542 (e.g., 542(1) and/or 542(2)), 642 for the one or more high-frequency stages at one or more different values than the delay value 422, 522, 622 for the low-frequency stage (e.g., setting the delay values 542(1) and 542(2) to different values than the delay value 522).

At step 708, the audio processing system 100 sets parameters for the crosstalk cancellation filters. In various embodiments, the crosstalk cancellation application 130 set parameters for the filters 138 that are to be applied to the midband feed 126 during the crosstalk cancellation stage 430, 530, 630. In some embodiments, the crosstalk cancellation application 130 identifies one or more transfer functions 132 specified in the dimensional map 134 based on the position and orientation of the listener 202. The crosstalk cancellation application 130 then uses the transfer functions 132 to configure one or more filters 138. In other words, the transfer functions 132 are used to model the output of a filter 138 given a particular audio signal that is provided as an input to the filter 138.

At step 710, the audio processing system 100 receives an input audio signal. In various embodiments, the audio playback module 120 receives the input audio signal 142 from the audio source 140. In some embodiments, the audio playback module 120 receives the input audio signal 142 as a plurality of signals. For example, the audio source 140 can transmit a plurality of input audio signals 142 that correspond to multiple channels (e.g., left channel, right channel, top channel, etc.) in a multichannel configuration. In such instances, the audio playback module 120 can process each channel in parallel. Alternatively, in some embodiments, the audio playback module 120 combines two or more input audio signals 142 corresponding to multiple channels before separating the input audio signal 142 into a plurality of audio feeds.

At step 712, the audio processing system 100 splits the input audio signal into the audio feeds. In various embodiments, the audio playback module 120 employs one or more crossovers 410, 510, 610 to split the input audio signal 142 into a plurality of audio feeds 122 that correspond to different frequency bands. For example, the audio playback module 120 can set the one or more crossovers 410, 510, 610 using the cutoff frequencies to generate the low-frequency feed 124, the midband feed 126, and the high-frequency feed 128. In some embodiments, the audio playback module 120 converts input audio signal 142 to the frequency domain (e.g., using a Fourier transform to transform the input audio signal 142 from the time domain to the frequency domain). For example, the audio playback module 120 can use a Fast Fourier Transform to transform the input audio signal 142 into one or more frequency components that correspond to the plurality of audio feeds 122.

At step 714, the audio processing system 100 applies the gain value and the delay value to the low-frequency feed. In various embodiments, the audio playback module 120 uses the low-frequency filter 420, 520, 620 in the low-frequency stage to apply the delay value 422, 522, 622 and the gain value 424, 524, 624 to the low-frequency feed 124. In some embodiments, the audio playback module 120 combines the low-frequency feeds 124 from two or more crossovers 510, 610 (e.g., the crossovers 510(1) and 510(2)) before applying a single low-frequency filter 520, 620 to the combined low-frequency feed 124. Additionally or alternatively, in some embodiments, a separate device (e.g., a subwoofer) processes the low-frequency feed 124. In such instances, the audio playback module 120 can cause the separate device to apply a low-frequency filter 420, 520, 620 that includes the selected delay value 422, 522, 622 and the selected gain value 424, 524, 624.

At step 716, the audio processing system 100 applies crosstalk cancellation to the midband feed. In various embodiments, the audio playback module 120 implements the crosstalk cancellation stage 430, 530, 630 by applying the set of filters 138 configured by the crosstalk cancellation application 130. In various embodiments, the set of filters 138 includes a set of filters for each channel in the channel layout. For example, when the audio processing system 100 is processing the audio signal for a 5.1 multichannel configuration that includes five channels of mid-frequency and high-frequency speakers 160, the set of filters 138 can include ten filters (a pair of filters 138 for each of the five audio channels) that are applied to the midband feed 126 (e.g., applying a first bank of filters 138(1) to the midband feed 126(1) and applying a second bank of filters 138(2) to the midband feed 126(2)). The application of the set of filters 138 generates the processed midband audio signals.

At step 718, the audio processing system 100 applies the gain value and the delay value to the high-frequency feed. In various embodiments, the audio playback module 120 uses the one or more high-frequency filters 440, 540, 640 in the high-frequency stage to apply the one or more delay values 442, 542, 642 and the one or more gain values 444, 544, 644 to the high-frequency feed 128. In some embodiments, the audio playback module 120 includes multiple high-frequency filters 540 (e.g., the high-frequency filters 540(1) and 540(2)) to process multiple high-frequency feeds 128. Alternatively, in some embodiments, the audio playback module 120 processes the high-frequency feeds 128 from two or more crossovers 610 (e.g., the crossovers 610(1) and 610(2)) before applying a single high-frequency filter 640 to the respective high-frequency feeds 128. In such instances, the audio playback module 120 can implement a splitter 646 to apply additional gains to the processed high-frequency audio signals for the respective audio channels. The processed high-frequency audio channel signals are then available for the multichannel combiners 650 to combine with multiple processed midband audio channel signals. For example, when the audio processing system 100 includes 5.1 multichannel configuration, the audio playback module 120 can implement the splitter 646 to split the processed high-frequency audio signal into five channels for combination with five processed midband audio signals.

At step 720, the audio processing system 100 combines the feed signals to generate the processed audio signals. In various embodiments, the audio playback module 120 implements one or more combiners 450, 552, 554, 650 to combine the processed audio signals generated by the separate processing stages. For example, the audio playback module 120 can combine the processed midband audio signal, the processed low-frequency audio signal, and the processed high-frequency audio signal to generate multiple processed audio signals 162. In some embodiments, the processed low-frequency audio signal remains separate from the other processed audio signals. For example, when producing audio for a 5.1 multichannel configuration, a separate device can generate and output the processed low-frequency audio signal 662 while the audio playback module 120 uses the multichannel combiners 650 to generate a set of five processed audio channel signals 664 for each of the five respective channels.

At step 722, the audio processing system 100 outputs the processed audio signals. In various embodiments, the audio playback module 120 transmits the processed audio signals 162 for output by a set of speakers 160. In such instances, the set of speakers 160 play back the processed audio signals 162 by outputting soundwaves in the environment based on the processed audio signals 162. The set of speakers 160 include one or more speakers corresponding to a left channel of the audio processing system 100 and one or more speakers corresponding to a right channel of the audio processing system 100. When played back in the environment, the processed midband audio signal portion of the processed audio signals 162 arrive at the left and right ear of the listener 202, respectively, with crosstalk being reduced or eliminated.

In sum, a crosstalk cancellation application configures a set of filters by selecting transfer functions based on the position and orientation of the listener's head within a three-dimensional space using sensor data from one or more sensors. An audio playback module receives the set of filters to perform crosstalk cancellation between the left and right channels of an audio source. The audio playback module also sets one or more frequency cutoffs for an input audio signal transmitted from the audio source separating the input audio signal into a plurality of audio feeds. The plurality of audio feeds includes a midband feed and one or more additional feeds, including a high-frequency feed and a low-frequency feed. The audio playback module performs crosstalk cancellation on the midband feed by applying the set of filters to generate a processed midband audio signal for the portion of the audio signal between the frequency cutoffs. The audio playback module also uses a low-frequency stage to apply a delay and gain to the low-frequency feed to generate a processed low-frequency audio signal that is synchronized and scaled to the processed midband audio signal. The audio playback module also uses a high-frequency stage to apply a separate delay and gain to the high-frequency feed to generate a processed high-frequency audio signal that is synchronized and scaled to the processed midband audio signal. The audio playback module combines the processed low-frequency, midband, and high-frequency audio signals to generate a set of processed audio signals for a full audio spectrum. The audio playback module transmits the processed audio signals to a set of speakers to reproduce the processed audio signal. When altered by the environment, the processed audio signal, once reaching the cars of a listener, have reduced or eliminated crosstalk in the midband of the audio spectrum.

At least one technical advantage of the disclosed techniques relative to the prior art is that, with the disclosed techniques, an audio processing system can implement crosstalk cancellation for an optimal frequency range of an audio signal without distorting other portions of the audio spectrum. In particular, by separating the audio signal into a plurality of audio feeds for separate frequency ranges, the audio processing system provides crosstalk cancellation without introducing errors in certain frequencies of the audio signal. The disclosed techniques provide improved crosstalk cancellation while reducing spectral distortions caused by errors included in the full audio spectrum. Additionally, the audio intended to be received by the user's left ear and right ear, respectively, more accurately represents the audio input that the audio processing system outputs. These technical advantages provide one or more technological advancements over prior art approaches.

1. In various embodiments, a computer-implemented method comprises generating, by an audio playback module from an input audio signal, a plurality of audio feeds that includes at least a midband feed and an additional feed, applying a crosstalk cancellation filter on the midband feed to generate a processed midband audio signal, applying an additional filter on the additional feed to generate an additional audio signal, where the additional filter applies at least a delay value to the additional feed, generating a plurality of processed audio signals based on both the processed midband audio signal and the additional audio signal, and transmitting, by the audio playback module, the plurality of processed audio signals to a plurality of speakers.

2. The computer-implemented method of clause 1, where the additional feed comprises a low-frequency feed, and the additional filter comprises a low-frequency filter.

3. The computer-implemented method of clause 1 or 2, where the additional feed comprises a high-frequency feed, and the additional filter comprises a high-frequency filter.

4. The computer-implemented method of any of clauses 1-3, further comprising generating, by a splitter and based on the additional audio signal, a plurality of processed high-frequency audio signals, where each processed high-frequency audio signal of the plurality of processed high-frequency audio signals corresponds to an audio channel in a multichannel configuration.

5. The computer-implemented method of any of clauses 1-4, where the additional filter is included in a separate device remote to the audio playback module.

6. The computer-implemented method of any of clauses 1-5, where the delay value is based at least on a distance between a separate device from which the additional audio signal is to appear to originate and at least one speaker included in the plurality of speakers.

7. The computer-implemented method of any of clauses 1-6, where the delay value is based at least on a delay associated with applying the crosstalk cancellation filter to the midband feed.

8. The computer-implemented method of any of clauses 1-7, where the additional filter also applies a gain value to the additional feed.

9. The computer-implemented method of any of clauses 1-8, where the gain value is based at least on an amplitude difference between the midband feed and the processed midband audio signal.

10. The computer-implemented method of any of clauses 1-9, further comprising setting one or more cutoff frequencies for the midband feed, where the cutoff frequency is based one or more mechanical characteristics of the plurality of speakers.

11. The computer-implemented method of any of clauses 1-10, where the crosstalk cancellation filter is included in a plurality of crosstalk cancellation filters, and the delay value is an average of a set of measured delays associated with applying the plurality of crosstalk cancellation filters on the midband feed.

12. The computer-implemented method of any of clauses 1-11, further comprising receiving a manual input for a second delay value, and adjusting, in real time, the additional filter to apply the second delay value to the additional feed.

13 The computer-implemented method of any of clauses 1-12, further comprising storing, by the audio playback module, a preset that includes a second delay value, receiving an input selecting the preset, retrieving the second delay value from the preset, and adjusting, in real time, the additional filter to apply the second delay value to the additional feed.

14. In various embodiments, one or more non-transitory computer-readable media store instructions that, when executed by one or more processors, cause the one or more processors to perform the steps of generating, by an audio playback module from an input audio signal, a plurality of audio feeds that includes at least a midband feed and an additional feed, applying a crosstalk cancellation filter on the midband feed to generate a processed midband audio signal, applying an additional filter on the additional feed to generate an additional audio signal, where the additional filter applies at least a delay value to the additional feed, generating a plurality of processed audio signals based on both the processed midband audio signal and the additional audio signal, and transmitting, by the audio playback module, the plurality of processed audio signals to a plurality of speakers.

15. The one or more non-transitory computer-readable media of clause 14, where the additional feed comprises a low-frequency feed, and the additional filter comprises a low-frequency filter.

16. The one or more non-transitory computer-readable media of clause 14 or 15, where the additional feed comprises a high-frequency feed, and the additional filter comprises a high-frequency filter.

17. The one or more non-transitory computer-readable media of any of clauses 14-16, where the delay value is based at least on a delay associated with applying the crosstalk cancellation filter to the midband feed.

18. The one or more non-transitory computer-readable media of any of clauses 14-17, where the additional filter also applies a gain value to the additional feed.

19. The one or more non-transitory computer-readable media of any of clauses 14-18, where the crosstalk cancellation filter is included in a plurality of crosstalk cancellation filters, and the delay value is an average of a set of measured delays associated with applying the plurality of crosstalk cancellation filters on the midband feed.

20 In various embodiments, a system comprises a memory storing an audio playback module, and a processor coupled to the memory that executes the audio playback module by performing the steps of generating, from an input audio signal, a plurality of audio feeds that includes at least a midband feed and an additional feed, applying a crosstalk cancellation filter on the midband feed to generate a processed midband audio signal, applying an additional filter on the additional feed to generate an additional audio signal, where the additional filter applies at least a delay value to the additional feed, generating a plurality of processed audio signals based on both the processed midband audio signal and the additional audio signal, and transmitting the plurality of processed audio signals to a plurality of speakers.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method, comprising:
generating, by an audio playback module from an input audio signal, a plurality of audio feeds that includes at least a midband feed and an additional feed;
applying a crosstalk cancellation filter on the midband feed to generate a processed midband audio signal;
applying an additional filter on the additional feed to generate an additional audio signal, wherein the additional filter applies at least a delay value to the additional feed;
generating a plurality of processed audio signals based on both the processed midband audio signal and the additional audio signal; and
transmitting, by the audio playback module, the plurality of processed audio signals to a plurality of speakers.

2. The computer-implemented method of claim 1, wherein the additional feed comprises a low-frequency feed, and the additional filter comprises a low-frequency filter.

3. The computer-implemented method of claim 1, wherein the additional feed comprises a high-frequency feed, and the additional filter comprises a high-frequency filter.

4. The computer-implemented method of claim 3, further comprising:
generating, by a splitter and based on the additional audio signal, a plurality of processed high-frequency audio signals,
wherein each processed high-frequency audio signal of the plurality of processed high-frequency audio signals corresponds to an audio channel in a multichannel configuration.

5. The computer-implemented method of claim 1, wherein the additional filter is included in a separate device remote to the audio playback module.

6. The computer-implemented method of claim 1, wherein the delay value is based at least on a distance between a separate device from which the additional audio signal is to appear to originate and at least one speaker included in the plurality of speakers.

7. The computer-implemented method of claim 1, wherein the delay value is based at least on a delay associated with applying the crosstalk cancellation filter to the midband feed.

8. The computer-implemented method of claim 1, wherein the additional filter also applies a gain value to the additional feed.

9. The computer-implemented method of claim 8, wherein the gain value is based at least on an amplitude difference between the midband feed and the processed midband audio signal.

10. The computer-implemented method of claim 1, further comprising:
setting one or more cutoff frequencies for the midband feed, wherein the cutoff frequency is based one or more mechanical characteristics of the plurality of speakers.

11. The computer-implemented method of claim 1, wherein:
the crosstalk cancellation filter is included in a plurality of crosstalk cancellation filters, and
the delay value is an average of a set of measured delays associated with applying the plurality of crosstalk cancellation filters on the midband feed.

12. The computer-implemented method of claim 1, further comprising:
receiving a manual input for a second delay value; and
adjusting, in real time, the additional filter to apply the second delay value to the additional feed.

13. The computer-implemented method of claim 1, further comprising:
storing, by the audio playback module, a preset that includes a second delay value;
receiving an input selecting the preset;
retrieving the second delay value from the preset; and
adjusting, in real time, the additional filter to apply the second delay value to the additional feed.

14. One or more non-transitory computer-readable media storing instructions that, when executed by one or more processors, cause the one or more processors to perform the steps of:
generating, by an audio playback module from an input audio signal, a plurality of audio feeds that includes at least a midband feed and an additional feed;
applying a crosstalk cancellation filter on the midband feed to generate a processed midband audio signal;
applying an additional filter on the additional feed to generate an additional audio signal, wherein the additional filter applies at least a delay value to the additional feed;
generating a plurality of processed audio signals based on both the processed midband audio signal and the additional audio signal; and
transmitting, by the audio playback module, the plurality of processed audio signals to a plurality of speakers.

15. The one or more non-transitory computer-readable media of claim 14, wherein the additional feed comprises a low-frequency feed, and the additional filter comprises a low-frequency filter.

16. The one or more non-transitory computer-readable media of claim 14, wherein the additional feed comprises a high-frequency feed, and the additional filter comprises a high-frequency filter.

17. The one or more non-transitory computer-readable media of claim 14, wherein the delay value is based at least on a delay associated with applying the crosstalk cancellation filter to the midband feed.

18. The one or more non-transitory computer-readable media of claim 14, wherein the additional filter also applies a gain value to the additional feed.

19. The one or more non-transitory computer-readable media of claim 14, wherein:
the crosstalk cancellation filter is included in a plurality of crosstalk cancellation filters, and
the delay value is an average of a set of measured delays associated with applying the plurality of crosstalk cancellation filters on the midband feed.

20. A system comprising:
a memory storing an audio playback module; and
a processor coupled to the memory that executes the audio playback module by performing the steps of:
generating, from an input audio signal, a plurality of audio feeds that includes at least a midband feed and an additional feed;
applying a crosstalk cancellation filter on the midband feed to generate a processed midband audio signal;
applying an additional filter on the additional feed to generate an additional audio signal, wherein the additional filter applies at least a delay value to the additional feed;
generating a plurality of processed audio signals based on both the processed midband audio signal and the additional audio signal; and
transmitting the plurality of processed audio signals to a plurality of speakers.
